(19) United States
(12) Patent Application Publication
(10) Pub. No.: US 2016/0054943 A1
(43) Pub. Date: Feb. 25, 2016

(54) INFORMATION PROCESSING APPARATUS

(71) Applicant: Kabushiki Kaisha Toshiba, Minato-ku (JP)

(72) Inventors: Kenichiro YOSHII, Bunkyo (JP); Kenichi MAEDA, Kamakura (JP); Nobuhiro KONDO, Yokohama (JP)

(73) Assignee: Kabushiki Kaisha Toshiba, Minato-ku (JP)

(21) Appl. No.: 14/636,337

(22) Filed: Mar. 3, 2015

Related U.S. Application Data
(60) Provisional application No. 62/040,687, filed on Aug. 22, 2014.

(51) Int. Cl. G06F 3/06

(52) U.S. Cl. CPC G06F 3/0622; G06F 3/0679; G06F 3/0659; G06F 3/0631

(57) ABSTRACT

According to one embodiment, an information processing apparatus includes a memory system and a host. The memory system includes a nonvolatile first memory and a first control unit. The host includes a volatile second memory and a second control unit. The second memory includes a first area which is used by the host and a second area which is used by the memory system. The second control unit transmits an access request to the first control unit. The access request contains an address. The first control unit determines whether an access destination is the first memory or the second area based on the address and accesses the determined access destination.

### CROSS-REFERENCE TO RELATED APPLICATIONS

This application is based upon and claims the benefit of priority from U.S. Provisional Application No. 62/040,687, filed on Aug. 22, 2014; the entire contents of which are incorporated herein by reference.

### FIELD

Embodiments described herein relate generally to an information processing apparatus.

### BACKGROUND

Conventionally, as a memory architecture of an information processing apparatus, a unified memory architecture (UMA) is known. The UMA is a memory architecture in which a memory built in a host is shared between the host and devices. According to the UMA, it is possible to achieve a reduction in memory cost.

### BRIEF DESCRIPTION OF THE DRAWINGS

FIG. 1 is a diagram illustrating an exemplary configuration of an information processing apparatus according to an embodiment;

FIG. 2 is a diagram illustrating an exemplary configuration of a DRAM;

FIG. 3 is a diagram for describing a logical block address space;

FIG. 4 is a schematic view illustrating a software configuration of the information processing apparatus;

FIG. 5 is a diagram for describing a process of an OS at the time of switching applications;

FIG. 6 is a flowchart for describing an operation of a memory manager;

FIG. 7 is a flowchart for describing an operation of a device driver;

FIG. 8 is a flowchart for describing an operation of a memory system for a Write access; and

FIG. 9 is a flowchart for describing an operation of the memory system for a Read access.

### DETAILED DESCRIPTION

In general, according to one embodiment, an information processing apparatus includes a memory system and a host. The memory system includes a nonvolatile first memory and a first control unit. The host includes a volatile second memory and a second control unit. The second memory includes a first area which is used by the host and a second area which is used by the memory system. The second control unit transmits an access request to the first control unit. The access request contains an address. The first control unit determines whether an access destination is the first memory or the second area based on the address and accesses the determined access destination.

Exemplary embodiments of an information processing apparatus will be explained below in detail with reference to the accompanying drawings. The present invention is not limited to the following embodiments.

### Embodiment

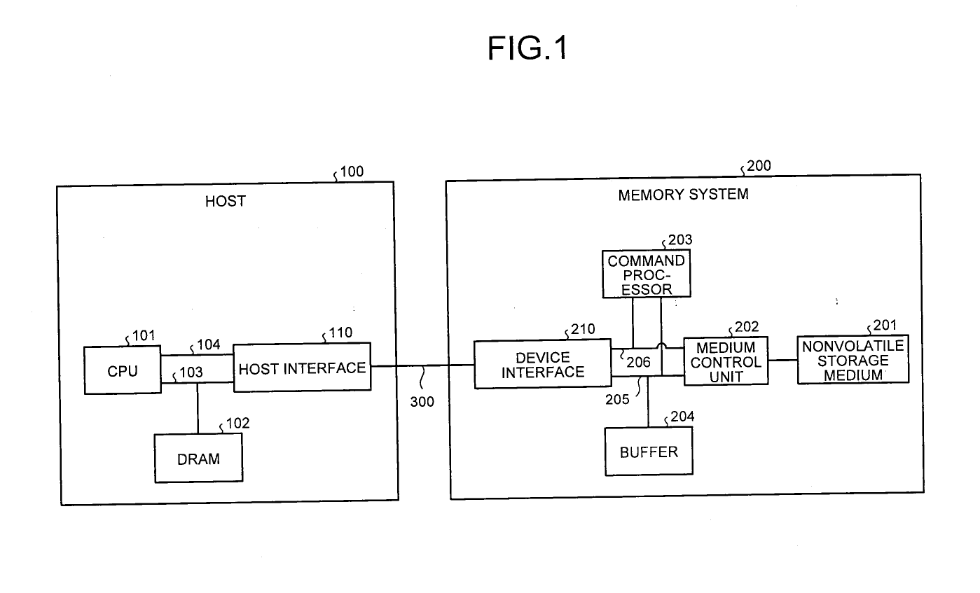

FIG. 1 is a diagram illustrating an exemplary configuration of an information processing apparatus according to the embodiment. An information processing apparatus 1 includes a host 100 and a memory system 200. The host 100 and the memory system 200 are connected to each other through a signal line 300. The information processing apparatus 1 may include various devices such as a display besides the above configuration.

The information processing apparatus 1, for example, is a server, a personal computer, a mobile phone, an image capturing apparatus, and the like. The standard with which the memory system 200 complies and the standard with which the signal line 300 complies are arbitrary. For example, the memory system 200 is a flash memory in conformity to a universal flash storage (UFS) standard. As a communication standard of the signal line 300, a mobile industry processor interface (MIPI) M-PHY is employed for example.

The host 100 includes a CPU 101, a dynamic random access memory (DRAM) 102, and a host interface 110. The CPU 101, the DRAM 102, and the host interface 110 are connected to each other through a data bus 103 and a control bus 104. In addition, the number of CPUs 101 included in the host 100 may be “2” or more. Further, the host 100 may employ other types of RAMs instead of the DRAM 102. For example, a static random access memory (SRAM), a magnetoresistive random access memory (MRAM), or a ferroelectric random access memory (FeRAM) may be employed.

The memory system 200 includes a nonvolatile storage medium 201, a medium control unit 202, a command processor 203, a buffer 204, and a device interface 210. The nonvolatile storage medium 201 and the medium control unit 202 are connected through a dedicated line. The medium control unit 202, the command processor 203, the buffer 204, and the device interface 210 are connected to each other through a data bus 205. Further, the medium control unit 202, the command processor 203, and the device interface 210 are connected to each other through a control bus 206. The nonvolatile storage medium 201 may be configured by employing an arbitrary medium. The nonvolatile storage medium 201, for example, may be configured by employing a NAND or NOR flash memory, an optical disk, a magnetic disk, or a combination thereof. The medium control unit 202 may be provided in the memory system 200 as many as the number of nonvolatile storage mediums 201 or for every type. As the buffer 204, a memory capable of high-speed operation may be employed. For example, a DRAM, an MRAM, a FeRAM, an SRAM, or a combination thereof may be employed as the buffer 204.

The respective applications operated on the CPU 101 of the host 100 transmits an access request to the memory system 200, to the host interface 110 through an operating system (OS) operated on the same CPU 101. When receiving the access request to the memory system 200 from the OS, the host interface 110 sends a command to the device interface 210. The command includes a process type, a logical block address (LBA) indicating a location of the head of a memory area to be processed, and a size of the memory area to be processed. The process type is “Read” or “Write”.

In the memory system 200, the device interface 210 sends the command received from the host interface 110 to the command processor 203. The command processor 203 checks whether the logical block address and the size contained in the command are those of the process target of the memory system 200, and then sends the command to the medium control unit 202. The medium control unit 202 performs a read/write process on the nonvolatile storage medium 201 according to the command.

Further, the device interface 210 can send a request to the host interface 110 for an access designating the DRAM 102 of the host 100. An area in the DRAM 102 to designate a data read/write from the device interface 210 is called a device area.

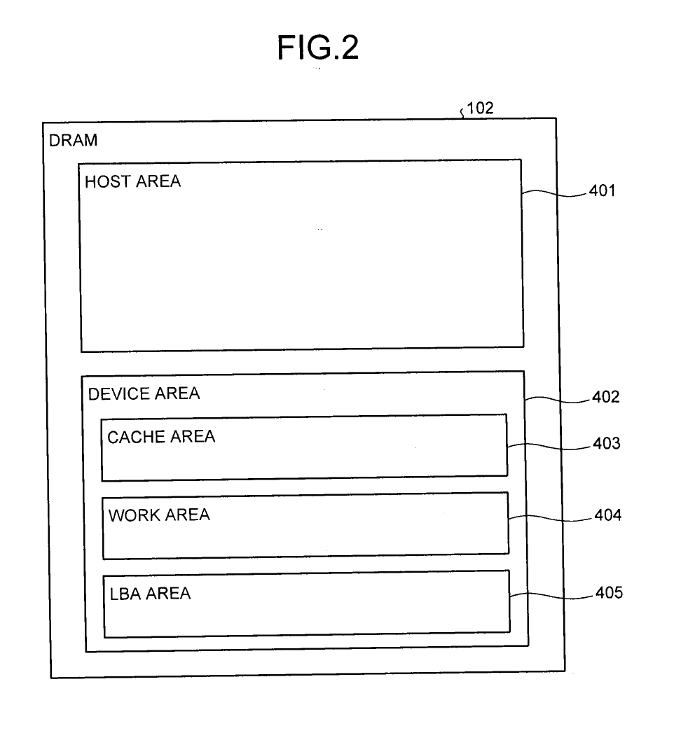

FIG. 2 is a diagram illustrating an exemplary configuration of the DRAM 102. The DRAM 102 includes a host area 401 and a device area 402. The device area 402 is set by a physical location of the head of the device area 402 and the size of the device area 402. The device area 402 includes a cache area 403, a work area 404, and an LBA area 405. The cache area 403 is an area where data (user data) written from the host 100 to the memory system 200 is cached. The work area 404 is an area where a program for control of the memory system 200 or management information to be used by the program is developed. The LBA area 405 will be described below. Securing the respective areas in the device area 402 is executed by the memory system 200.

The host interface 110 can request an access to the LBA area 405 to the device interface 210. When the host interface 110 requests the access to the LBA area 405, a logical block address which is different from that used in access to the nonvolatile storage medium 201 is designated. In other words, the LBA area 405 is mapped with the logical block address which is different from the logical block address mapped to the nonvolatile storage medium 201.

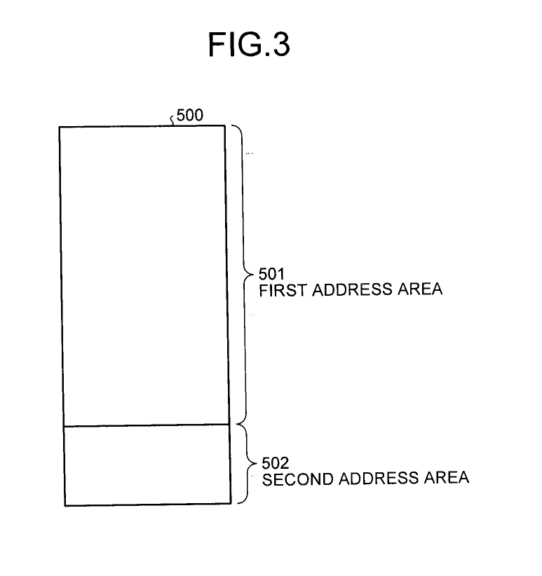

FIG. 3 is a diagram illustrating a logical block address space which is used by the host 100 for the access request to the memory system 200. A logical block address space 500 includes a first address area 501 which is mapped to the nonvolatile storage medium 201, and a second address area 502 which is mapped to the LBA area 405. The second address area 502 is set by the logical block address of the head of the second address area 502 and the size of the second address area 502. The size of the second address area 502 is equal to that of the LBA area 405.

For example, the logical block address of the head of the second address area 502 and the size of the second address area 502 are notified the memory system 200 of from the host 100 at a predetermined timing point (for example, at the time of activation or the like). Then, the memory system 200 secures a memory area defined by the size of the second address area 502 in the device area 402, and sets the memory area to the LBA area 405. Then, the memory system 200 maps the logical block address of the head of the second address area 502 to the location of the head of the LBA area 405.

Further, for example, the logical block address of the head of the second address area 502 and the size of the second address area 502 are previously stored in the memory system 200. The logical block address of the head of the second address area 502 and the size of the second address area 502 are notified the host 100 of from the memory system 200 at a predetermined timing point (for example, at the time of activation). The host 100 can recognize the second address area 502 based on the logical block address of the head of the second address area 502 and the size of the second address area 502.

In a case where the host 100 requests an access designating the logical block address in the first address area 501, the access is performed on the nonvolatile storage medium 201. On the other hand, in a case where the host 100 requests an access designating the logical block address in the second address area 502, the access is performed on the LBA area 405.

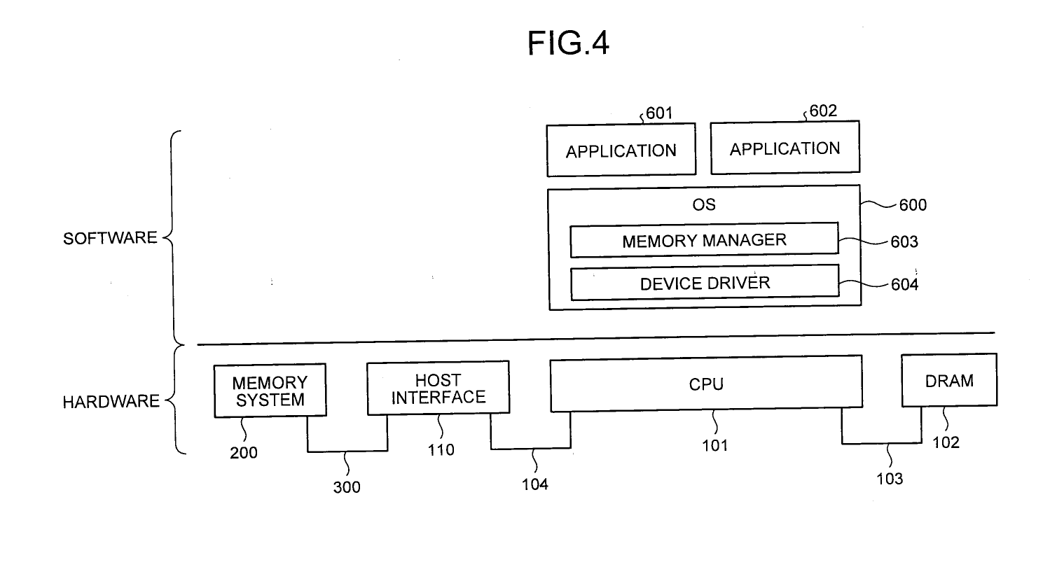

FIG. 4 is a schematic view illustrating the software configuration of the information processing apparatus 1. On the CPU 101, an OS 600 and a plurality of applications (herein, an application 601 and an application 602) are operated. The OS 600 and the respective applications 601 and 602 are stored as programs in the memory system 200. The respective programs are developed in the host area 401 at run time. The CPU 101 realizes the function of the OS 600, the application 601, or the application 602 based on the corresponding program developed in the host area 401.

The application 601 and the application 602 are operated on the CPU 101 while being switched in time by the OS 600. The application 601 and the application 602 can access the DRAM 102 through the OS 600 and the data bus 103 during operation. Further, the application 601 and the application 602 can access the memory system 200 by making an access to the host interface 110 through the OS 600 and the control bus 104 during operation.

Further, the OS 600-includes a memory manager (a management unit) 603 which executes a switching of the application and a device driver (an allocation unit) 604 which allocates the memory. Further, the device driver 604 has a function as an authentication unit which performs authentication of an access source. In addition, the authentication unit may be realized in the memory system 200 (for example, the command processor 203).

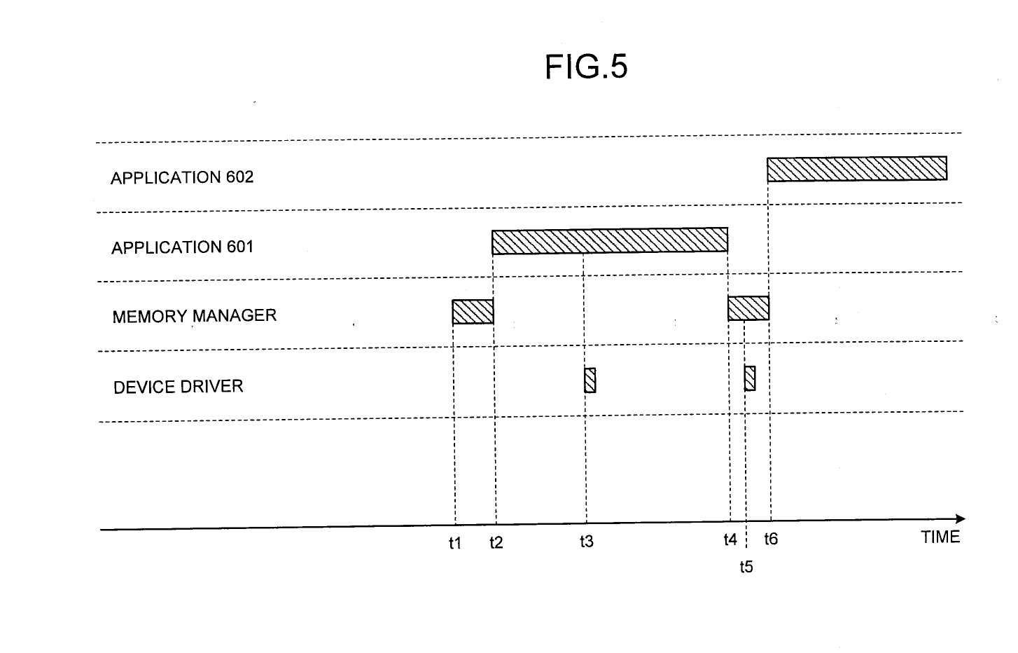

FIG. 5 is a diagram for describing a process of the OS 600 at the time of switching the applications. The memory manager 603 starts to operate from time t1, the control is shifted to the application 601 at time t2, and the application 601 starts to operate from time t2. The application 601 operates while using the work area in the host area 401. Specifically, in a case where the application 601 generates temporary data, the temporary data is stored in the memory area which is previously secured as the work area in the host area 401. In a case where predetermined secret information is necessary to be stored at time t3, the application 601 secures a storage destination of the secret information in the LBA area 405. In this case, the application 601 transmits a secure request to the device driver 604 to secure a separate memory area in the LBA area 405. Herein, the LBA area 405 is necessary to be authenticated for the use. The application 601 transmits the secure request along with a certificate. The certificate is information for proving the identity of the transmission source of the request. Herein, the application 601 transmits the certificate for proving that the transmission source of the secure request is the application 601. Through the authentication of the certificate from the application 601, it is determined whether the secure request is transmitted by any software while faking its identity as the application 601. After the authentication of the certificate from the application 601, the device driver 604 secures the requested memory area in the LBA area 405. The application 601 can access the memory area by issuing an access request which contains a logical block address indicating the memory area secured in the LBA area 405. The application 601 attaches the certificate even to the access request of which the access destination is the memory area secured in the LBA area 405. When the authentication of the certificate attached to the access request is successful, the access to the memory area is permitted.

When the process is completed or the run time allocated to the application 601 has elapsed, the process moves to the OS 600. When the control moves from the application 601 to the OS 600 at time t4, the memory manager 603 operates. The memory manager 603 transmits the secure request to the device driver 604 at time t5 in order to save the data of the application 601 in the work area. The transmission of the secure request is executed as a trigger to switch the application. The memory manager 603 transmits the secure request along with the certificate for proving that the transmission source is the memory manager 603. The device driver 604 secures the requested memory area in the LBA area 405. The memory manager 603 saves the data of the application 601 stored in the memory area of the host area 401 into the memory area secured in the LBA area 405. When the data is saved, the memory manager 603 issues an access request with the certificate attached. In a case where the authentication by the certificate is successfully passed, the data can be saved into the memory area. After the saving is completed, the memory manager 603 switches the control to the application 602 at time t6. The application 602 starts to operate while using the empty work area generated due to the saving.

In this way, the application 601 and the application 602 are operated in a time sharing manner. Further, since the destination of the data to be saved at the time of switching the application is the LBA area 405 in the DRAM 102, for example, even in a case where the application 601 writes the secret information in the work area, the switching of the application does not cause the secret information to be saved into the nonvolatile storage medium 201. Therefore, the secret information is improved in confidentiality.

Next, the operation of the information processing apparatus 1 according to the embodiment will be described.

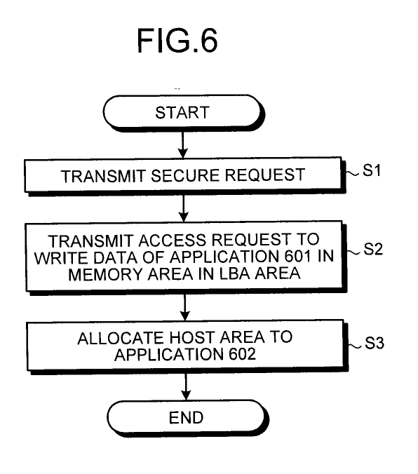

FIG. 6 is a flowchart for describing the operation of the memory manager 603. Herein, the operation performed when the control is switched from the application 601 to the application 602 will be described.

When the application is switched, the memory manager 603 transmits the secure request to the device driver 604 (S1). The secure request transmitted at S1 is a request for securing the memory area in the LBA area 405. The secure request contains a designation of the size of the memory area to be secured. Further, a designation of a volatile area is attached to the secure request in order to secure the memory area in the LBA area 405. The designation of the volatile area means that a request is made for securing the memory area in the LBA area 405. In a case where the designation of the volatile area is not attached to the secure request, the secure request is interpreted as a request for securing the memory area in the nonvolatile storage medium 201. In a case where the designation of the volatile area is attached to the secure request, the certificate for proving the transmission source is necessarily attached. In the process of S1, the memory manager 603 attaches the designation of the size of the memory area, the designation of the volatile area, and the certificate for proving that the transmission source is the memory manager 603 to the secure request.

After securing the memory area in the LBA area 405, the memory manager 603 transmits an access request for writing the memory area in which the data of the application 601 in the host area 401 is secured in the LBA area 405 (S2). The access request for setting the memory area in the LBA area 405 as an access destination is necessarily attached with the certificate. In the process of S2, the memory manager 603 attaches the certificate for proving that the transmission source is the memory manager 603 to the access request. After the authentication by the device driver 604, the access request is transmitted to the memory system 200 through the host interface 110, and executed in the memory system 200.

After the data is completely saved through the process of S2, the memory manager 603 allocates the host area 401 to the application 602 (S3), and the operation is ended.

In addition, the secure request for securing the memory area in the LBA area 405 and the access request for accessing the memory area secured in the LBA area 405 can also be transmitted by the application 601 or the application 602.

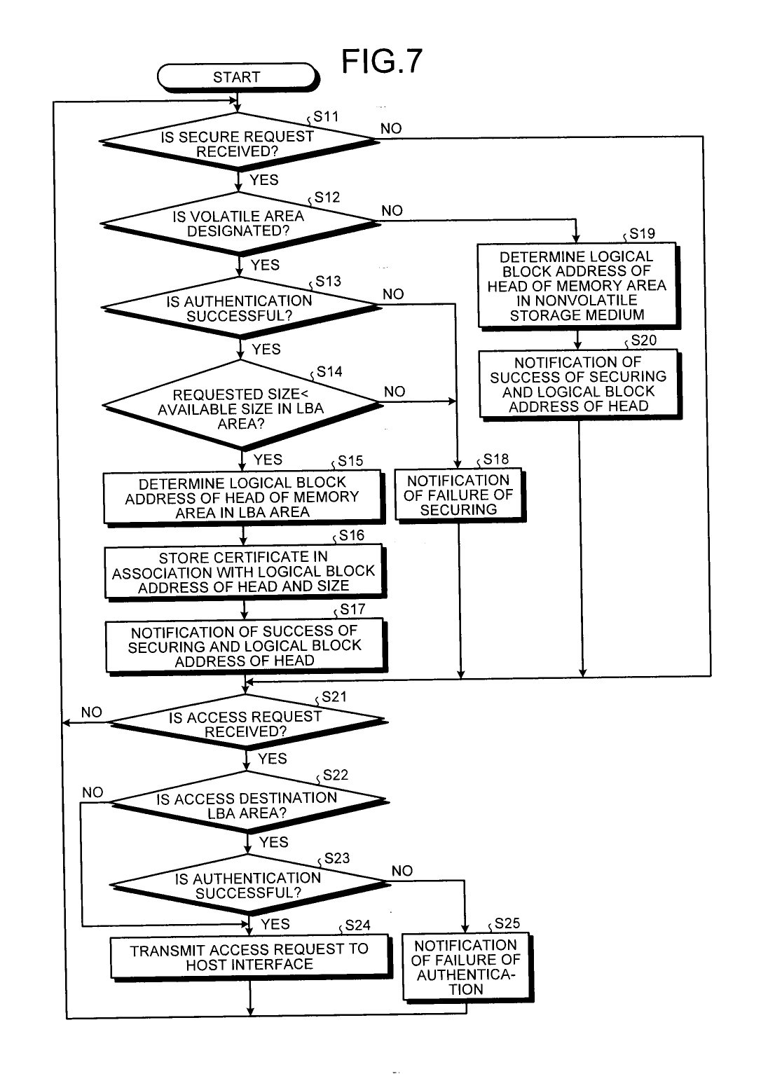

FIG. 7 is a flowchart for describing an operation of the device driver 604. The device driver 604 determines whether the secure request is received (S11). When the secure request is received (Yes in S11), the device driver 604 determines whether the designation of the volatile area is contained in the secure request (S12). In a case where the designation of the volatile area is contained in the secure request (Yes in S12), the device driver 604 performs the authentication using the certificate contained in the secure request, and determines whether the authentication is successful (S13). In a case where the authentication is successful (Yes in S13), the device driver 604 determines whether the size of the memory area requested by the secure request is smaller than the size of an available area in the LBA area 405 (that is, the size of an empty area) (S14). In a case where the size of the memory area requested by the secure request is smaller than the size of the empty area (Yes in S14), the device driver 604 determines the logical block address of the head of the memory area (S15). The device driver 604 stores the certificate in association with the logical block address of the head and the size (S16). Then, the device driver 604 notifies the transmission source of the secure request of success of the securing along with the determined logical block address of the head (S17).

In a case where the authentication is failed (No in S13), or in a case where the size of the memory area requested by the secure request is larger than the size of the empty area (No in S14), the device driver 604 notifies the transmission source of the secure request of failure of the securing (S18).

In a case where the designation of the volatile area is not contained in the secure request (No in S12), the device driver 604 determines the logical block address of the head of the memory area in the nonvolatile storage medium 201 (S19). The device driver 604 notifies the transmission source of the secure request of success of the securing along with the logical block address of the head (S20).

In a case where the secure request is not received (No in S11), after the process of S17, after the process of S18, or after the process of S20, the device driver 604 determines whether the access request is received (S21). In a case where the access request is received (Yes in S21), the device driver 604 determines whether the access destination is the LBA area 405 based on the logical block address contained in the access request (S22). In a case where the logical block address contained in the access request is contained in the first address area 501, it is determined that the access destination is not the LBA area 405 but the nonvolatile storage medium 201. In a case where the logical block address contained in the access request is contained in the second address area 502, it is determined that the access destination is the LBA area 405.

In a case where the access destination is the LBA area 405 (Yes in S22), the device driver 604 performs the authentication by comparing the certificate attached to the access request with a certificate previously stored, and determines whether the authentication is successful (S23). For example, in a case where the transmission source of the access request is matched with the transmission source of the secure request, it is determined that the authentication is successful. Further, in a case where the transmission source of the access request is not matched with the transmission source of the secure request, it is determined that the authentication is failed. In a case where the authentication is successful (Yes in S23), the device driver 604 transmits the access request to the host interface 110 (S24). In a case where the authentication is failed (No in S23), the device driver 604 does not transmit the access request to the host interface 110 but notifies the transmission source of the access request of failure of the authentication (S25). In a case where the access request is not received (No in S21), after the process of S24, or after the process of S25, the device driver 604 performs the process of S11.

In a case where the access destination is not the LBA area 405 (No in S22), that is, a case where the access destination is the nonvolatile storage medium 201, the device driver 604 does not perform the authentication but performs the process of S24.

Next, the operation, after the access request is sent to the host interface 110 will be described. When receiving the access request, the host interface 110 sends a command according to the access request to the device interface 210. In a case where a Write access is requested by the access request, the host interface 110 sends a Write command to the device interface 210. In a case where a Read access is requested by the access request, the host interface 110 sends a Read command to the device interface 210.

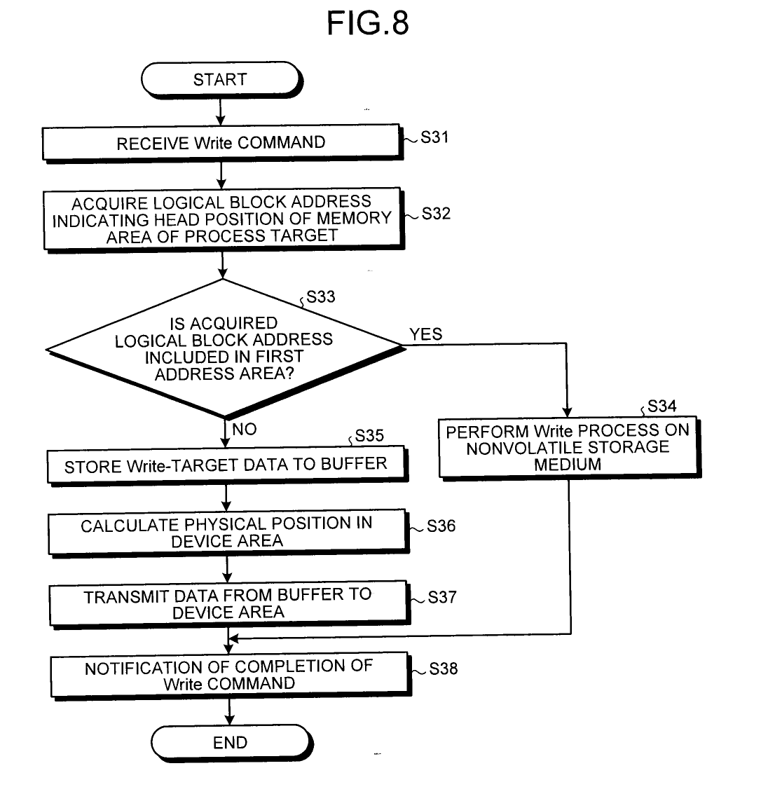

FIG. 8 is a flowchart for describing an operation of the memory system 200 relating to the Write access. First, the device interface 210 receives the Write command from the host interface 110 (S31). The device interface 210 sends the received Write command to the command processor 203. The command processor 203 acquires the logical block address indicating the head location of the memory area which is a process target of the Write command (S32). The command processor 203 determines whether the acquired logical block address is contained in the first address area 501 (S33). In a case where the acquired logical block address is contained in the first address area 501 (Yes in S33), the command processor 203 sends the Write command to the medium control unit 202. The medium control unit 202 performs a Write process on the nonvolatile storage medium 201 (S34).

In a case where the acquired logical block address is not contained in the first address area 501 (No in S33), that is, a case where the acquired logical block address is contained in the second address area 502, the device interface 210 receives Write-target data from the host interface 110 and stores the received data in the buffer 204 (S35). Then, the command processor 203 calculates a physical location in the device area 402 which is indicated by the acquired logical block address (S36).

In the process of S36, the physical location in the device area 402, for example, is calculated as follows. The physical location in the device area 402 which is indicated by the logical block address acquired from the Write command is given by “(LBAREQ−LBAUM_START)×512+UM_ADDR_HEAD+offset”. Herein, the size of a logical block is set to 512 bytes, the logical block address acquired from the Write command is denoted by “LBAREQ”, the logical block address of the head of the second address area 502 is denoted by “LBAUM_START”, the physical location of the head of the device area 402 is denoted by “UM_ADDR_HEAD”, and an offset value of the physical location of the head of the LBA area 405 with respect to the physical location of the head of the device area 402 is denoted by “offset”. “LBAUM_START”, “UM_ADDR_HEAD”, and “offset” are managed by the command processor 203.

The command processor 203 instructs the device interface 210 to transmit the data received at S35 to the physical location calculated through the process of S36. The device interface 210 transmits a command to the host interface 110 to send the data stored in the buffer 204 at S35 to the physical location of the device area 402 which is calculated at S36, and sends the data to the device area 402 of the DRAM 102 (S37). After the process of S34 or S37, the command processor 203 notifies the host interface 110 through the device interface 210 of the completion of the Write command received by the process of S31 (S38). After the process of S38, the operation of the memory system 200 is ended.

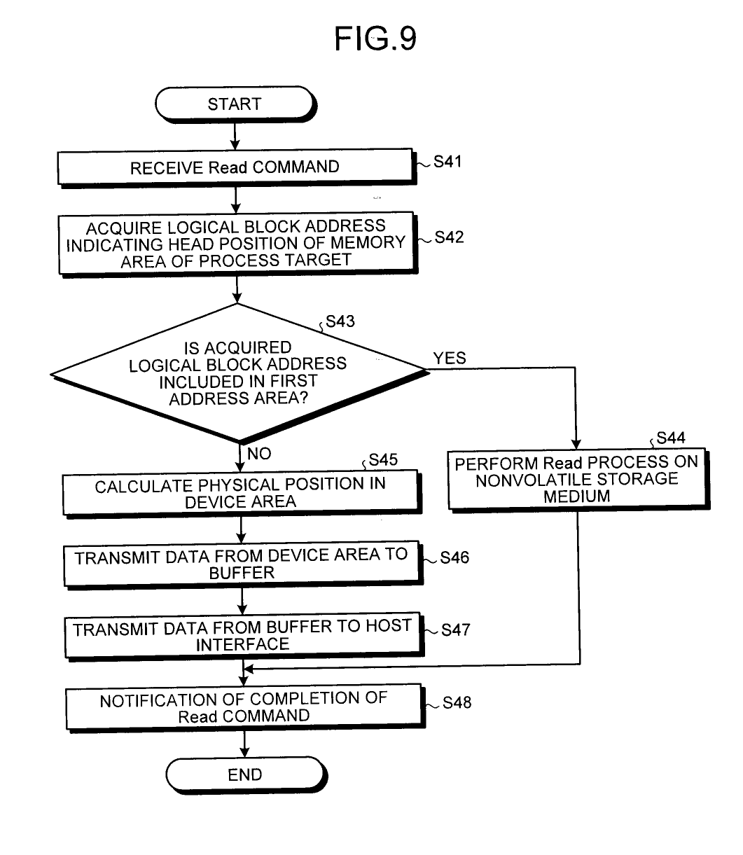

FIG. 9 is a flowchart for describing an operation of the memory system 200 relating to a Read access. First, the device interface 210 receives the Read command from the host interface 110 (S41). The device interface 210 sends the received Read command to the command processor 203. The command processor 203 acquires the logical block address indicating the head location of the memory area which is a process target of the Read command (S42). Then, the command processor 203 determines whether the acquired logical block address is included in the first address area 501 (S43). In a case where the acquired logical block address is included in the first address area 501 (Yes in S43), the command processor 203 sends the Read command to the medium control unit 202. The medium control unit 202 performs a Read process on the nonvolatile storage medium 201 (S44).

In a case where the acquired logical block address is not included in the first address area 501 (No in S43), that is, a case where the acquired logical block address is included in the second address area 502, the command processor 203 calculates the physical location in the device area 402 which indicates the acquired logical block address (S45). The calculation of the physical location is performed by the same manner as the process of S36. The command processor 203 instructs the device interface 210 to transmit a command to the host interface 110 to read the data from the physical location on the DRAM 102 which is calculated by the process of S45. In a case where the device interface 210 receives a response to the command from the host interface 110, the device interface 210 stores the data read out of the DRAM 102 contained in the received response into the buffer 204 (S46). Then, the command processor 203 causes the device interface 210 to send the data from the buffer 204 to the host interface 110 (S47). After the process of S44 or S47, the command processor 203 notifies the host interface 110 through the device interface 210 of the completion of the Read command received by the process of S41 (S48). After the process of S48, the operation of the memory system 200 is ended.

According to the embodiment as described above, the DRAM 102 included in the host 100 includes the device area 402 which is used by the memory system 200. Then, the LBA area 405 mapped to the logical block address space 500 which is used by the host 100 is secured in the device area 402. The command processor 203 determines whether the access destination is the nonvolatile storage medium 201 or the LBA area 405 based on whether the address contained in the command is included in the first address area 501 mapped to the nonvolatile storage medium 201 or the second address area 502 mapped to the LBA area 405. Then, the command processor 203 accesses the determined access destination. Therefore, the host 100 can make an access to the LBA area 405 secured in the DRAM 102 in the same manner as the access to the nonvolatile storage medium 201.

Further, a correspondence relation between the physical location of the LBA area 405 and the logical block address is managed by the command processor 203. Therefore, since the host 100 does not need to manage the LBA area 405, the logical block address space 500 is easily managed by the host 100.

Further, the CPU 101 realizes the memory manager 603 and the device driver 604. Further, the CPU 101 can realize the application 601 and the application 602. When the control is switched from the application 601 to the application 602, the memory manager 603 saves the data relating to the application 601 in the host area 401 into the LBA area 405, and then permits the application 602 to use the host area 401. Since the temporary data used by the application 601 is stored not in the nonvolatile storage medium 201 but in the LBA area 405 in the DRAM 102 which is managed by the memory system 200, it is prevented that the temporary data from being illegally read through the nonvolatile storage medium 201.

Specifically, the memory manager 603 transmits the secure request to the device driver 604. The device driver 604 secures the memory area requested by the secure request in the LBA area 405. The memory manager 603 saves the data used by the application 601 into the memory area secured in the LBA area 405.

Further, the memory manager 603 attaches the certificate for proving that the transmission source is the memory manager 603 to the secure request. The device driver 604 performs the authentication based on the certificate, and secures the memory area in the LBA area 405 in a case where the authentication is successful. Since there is a need to perform the authentication when the LBA area 405 is used, a security for the data in the LBA area 405 is improved.

Further, the transmission source of the access request attaches the certificate of the transmission source to the access request. When the access request for the LBA area 405 is transmitted, the device driver 604 performs the authentication using the certificate attached to the access request. The authentication is performed by comparing the certification attached to the secure request with the certificate attached to the access request. In a case where the authentication is successful, the device driver 604 permits execution of the access request. Therefore, in a case where the transmission source of the access request is different from the transmission source of the secure request, the access to the LBA area 405 is forbidden, so that the security for the data in the LBA area 405 is improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory system comprising a nonvolatile first memory and a first control unit; and
a host comprising a volatile second memory and a second control unit, the second memory comprising a first area which is used by the host and a second area which is used by the memory system; wherein
the second control unit transmits an access request to the first control unit, the access request containing an address, and
the first control unit determines whether an access destination is the first memory or the second area based on the address and accesses the determined access destination.

2. The information processing apparatus according to claim 1,
wherein the first control unit determines the access destination based on whether the address is included in a first address range or a second address range.

3. The information processing apparatus according to claim 2,
wherein the address included in the first address range is an address which is mapped to the first memory, and
wherein the address included in the second address range is an address which is mapped to the second area.

4. The information processing apparatus according to claim 3,
wherein the first control unit manages a correspondence relation between the address included in the second address range and a physical location in the second area.

5. The information processing apparatus according to claim 4,
wherein in response to a write command in which the address included in the second address range is designated, the first control unit specifies a physical location in the second area which corresponds to the address designated by the write command, and transmits a transmission command which contains the specified physical location to the host.

6. The information processing apparatus according to claim 4,
wherein the second control unit executes an application using the first area, and when an execution target is switched from a first application to a second application, transmits the write command to the memory system to designate data in the first area and a save destination address, the data being used in the execution of the first application, the save destination address indicating a destination where the data is saved.

7. The information processing apparatus according to claim 6,
wherein the second control unit transmits, when the data being used in the execution of the first application includes a secret information, the write command including the save destination address corresponding to the second area.

8. The information processing apparatus according to claim 6,
wherein the first control unit receives the write command, and in a case where the save destination address is included in the second address range, specifies a physical location in the second area corresponding to the save destination address and transmits a transmission command containing the specified physical location to the host.

9. The information processing apparatus according to claim 8,
wherein after the transmission to the specified physical location is completed, the first control unit executes the second application using the first area.

10. The information processing apparatus according to claim 6,
wherein the second control unit further comprises an allocation unit, and
a management unit which transmits a secure request to the allocation unit to request for securing a memory area in the second area in a case where the destination where the data is saved is included in the second address range.

11. The information processing apparatus according to claim 10,
wherein the management unit adds a first certificate to the secure request, and
wherein the allocation unit performs an authentication based on the first certificate, determines a head logical block address of the memory area in a case where the allocation unit succeeds in the authentication, and notifies the management unit of the determined head logical block address.

12. The information processing apparatus according to claim 11,
wherein the management unit transmits an access request containing the head logical block address and a second certificate to the allocation unit, and
wherein the allocation unit determines whether an access to the second area is permitted based on the first certificate and the second certificate.

13. The information processing apparatus according to claim 12,
wherein in a case where a transmission source of the first certificate is matched to a transmission source of the second certificate, the allocation unit permits the access to the second area and transmits the write command to the memory system.

14. The information processing apparatus according to claim 2, further comprising:
an allocation unit,
wherein the second control unit transmits a secure request to the allocation unit to request for securing a memory area in the second area.

15. The information processing apparatus according to claim 14,
wherein the second control unit transmits an access request which contains a logical block address in the memory area and a second certificate to the allocation unit, and
wherein the allocation unit determines whether the access to the second area is permitted based on a first certificate and the second certificate.

16. The information processing apparatus according to claim 15,
wherein in a case where a transmission source of the first certificate is matched to a transmission source of the second certificate, the allocation unit permits the access to the second area and transmits the access request to the memory system.

17. The information processing apparatus according to claim 1,
wherein the second control unit transmit the access request to write a secret information into the second area.

18. The information processing apparatus according to claim 1,
wherein the second control unit executes an application using the first area, and when an execution target is switched from a first application to a second application, transmits the access request including a save destination of a secret information, the save destination being in the second area, the secret information being included in data being used in the execution of the first application.
